(19) United States
(12) Patent Application Publication
(10) Pub. No.: US 2024/0094491 A1
(43) Pub. Date: Mar. 21, 2024

(54) MINIATURE AND EASY-TO-STRIPPING BUTTERFLY-SHAPED PHOTOELECTRIC COMPOSITE COMMUNICATION OPTICAL CABLE

(71) Applicant: Huizhou Fibercan Industrial Co.,Ltd, Huizhou (CN)

(72) Inventor: YAOLE LI, Huizhou (CN)

(21) Appl. No.: 18/133,155

(22) Filed: Apr. 11, 2023

(30) Foreign Application Priority Data
Sep. 19, 2022 (CN) 202222476066.0

(51) Int. Cl. G02B 6/44

(52) U.S. Cl. CPC G02B 6/4432

(57) ABSTRACT

The present application discloses a miniature and easy-to-stripping butterfly-shaped photoelectric composite communication optical cable, comprising an optical cable part and a cable part fixedly connected to a side of the optical cable part, the optical cable part comprises an optical transmission conductor, an optical cable sheath, and reinforcing components, the cable part comprises a cable sheath and an electrical transmission conductor, the electrical transmission conductor and the optical transmission conductor extend in parallel in the same direction, and photoelectric separation ports are provided between the cable sheath and the optical cable sheath. The optical cable part is arranged separately from the cable part, and the magnetic field generated when the cable part transmits power has a certain distance from the optical cable part, which does not affect the signal transmission of the optical cable part.

### CROSS-REFERENCE TO RELATED APPLICATIONS

This application claims the benefit and priority of Chinese patent application No. 202222476066.0, filed on Sep. 19, 2022, disclosure of which is hereby incorporated by reference in its entirety.

### TECHNICAL FIELD

The present application relates to the technical field of communication, in particular to a miniature and easy-to-stripping butterfly-shaped photoelectric composite communication optical cable.

### BACKGROUND

With the increasing demand for communication bandwidth and the development of mobile communication 5G, the scale of distributed base stations that the communication industry will continue to use will become smaller, faster, and lower cost. The traditional method usually uses an independent power cable to supply power to the RRU on the top of the tower, and uses an independent optical fiber for signal transmission. Although the above solution can meet the basic transmission requirements, since the cables for power supply and signal transmission are laid independently, multiple constructions are required, which cannot meet the needs of rapid and low-cost 5G construction, and the independent laying of cables takes up more pipeline resources, which is not suitable for tiny objects. There are also some cables that combine power supply and signal transmission cables, such as Chinese patent application CN201920907785.9. It discloses a self-supporting optical fiber cable, the optical transmission conductor part of this cable and the electric transmission conductor part are combined in the same sheath, the magnetic field generated by the electric transmission conductor when transmitting electricity affects the optical transmission part, and it is inconvenient to strip the optical fiber and the electrical transmission conductor from the photoelectric separation port for on-site application, and there is a risk of damaging the optical fiber when separating the electrical transmission conductor part. The present application is dedicated to solving the above problems.

### SUMMARY

In order to overcome the deficiencies of the prior art, the present application provides a miniature and easy-to-stripping butterfly-shaped photoelectric composite communication optical cable.

In order to solve this technical problem, the application proposes: A miniature and easy-to-stripping butterfly-shaped photoelectric composite communication optical cable, comprising an optical cable part and a cable part fixedly connected to a side of the optical cable part, the optical cable part comprises an optical transmission conductor, an optical cable sheath arranged on outer surface of the optical transmission conductor and extending parallel to the optical transmission conductor, and reinforcing components arranged inside the optical cable sheath and respectively arranged on both sides of the optical transmission conductor, the reinforcing component extends parallel to the same direction as the optical transmission conductor, the cable part comprises a cable sheath fixedly connected to outer side of the optical cable sheath, an electrical transmission conductor arranged inside the cable sheath, the electric transmission conductor extends parallel to the same direction as the optical transmission conductor, and photoelectric separation ports are provided between the cable sheath and the optical cable sheath.

Further, the optical cable sheath comprises a first sheath and a second sheath with a circular cross section, a left side of the cross section of the first sheath intersects the right side of the cross section of the second sheath to form a lying “8” shape, at intersections of outer contours of the first sheath and the second sheath, inwardly directed optical cable separation ports are respectively provided, and two optical cable separation ports are provided, the optical transmission conductor is located in middle of the two optical cable separation ports, the first sheath, the second sheath, the optical cable separation ports, the cable sheath, the photoelectric separation ports are integrally formed.

Further, the first sheath and the second sheath have the same diameter, the cross section of the cable sheath is circular, and the diameter of the cable sheath is smaller than the diameters of the first sheath and the second sheath.

Further, the reinforcing component comprises a first reinforcing member arranged in the first sheath, a second reinforcing member arranged in the second sheath, the optical transmission conductor comprises a tight sleeve arranged between two optical cable separation ports, an optical fiber arranged in the tight sleeve, the cross section of the first reinforcing member and the second reinforcing member is circular and have the same diameter, a diameter of the tight sleeve is smaller than the diameters of the first reinforcing member and the second reinforcing member, a distance from center of the first reinforcing member to center of the second sheath is equal to a distance from center of the second reinforcing member to center of the second sheath.

Further, centers of the electrical transmission conductor, the first reinforcing member, the tight sleeve, the optical fiber and the second reinforcing member are located on the same straight line.

The beneficial effect of the present application is to provide a miniature and easy-to-stripping butterfly-shaped photoelectric composite communication optical cable. The optical cable part is arranged separately from the cable part, and the magnetic field generated when the cable part transmits power has a certain distance from the optical cable part, which does not affect the signal transmission of the optical cable part, and ensures the quality of the signal transmission of the optical fiber. When it is necessary to strip the optical fiber and the electrical transmission conductor from the photoelectric separation port for indoor connection, it is convenient for the user to grasp the application and apply force better. A photoelectric separation port is provided between the cable sheath and the optical cable sheath, and an optical cable separation port is provided at an intersection of an outer contours of the first sheath and the second sheath, which is convenient for the cable part and the optical cable part to be stripped for installation. The application has the advantages of simple structure, small cable diameter and light cable weight, thereby reducing the cost of the optical cable.

### BRIEF DESCRIPTION OF DRAWINGS

FIG. 1 is a schematic structural diagram of a miniature and easy-to-stripping butterfly-shaped photoelectric composite communication optical cable according to the present application.

FIG. 2 is a schematic structural diagram of the cross section of miniature and easy-to-stripping butterfly-shaped photoelectric composite communication optical cable according to the present application.

### DETAILED DESCRIPTION

Embodiments of the present application will be described below in conjunction with the accompanying drawings and related embodiments. The implementation of the present application is not limited to the following examples, and the relevant necessary components related to the technical field of the present application should be regarded as well-known technologies in the technical field, which are known and mastered by those skilled in the technical field.

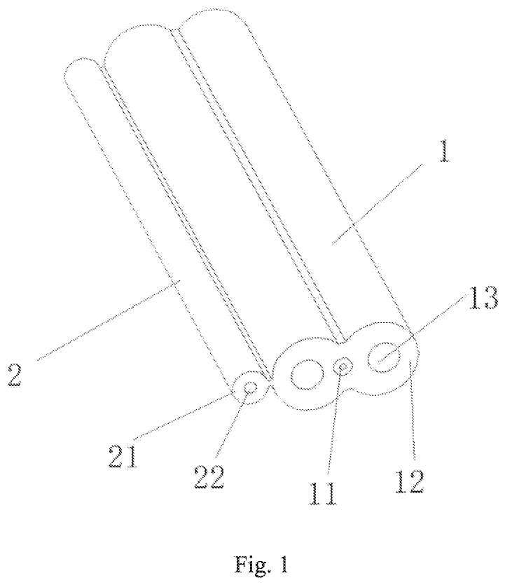

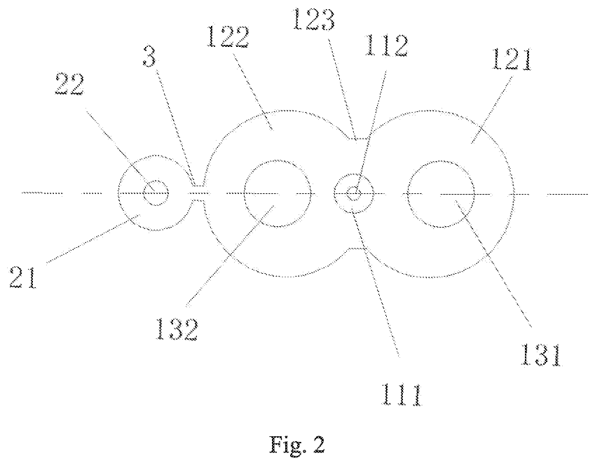

With reference to FIG. 1 to FIG. 2, this application is realized as follows: A miniature and easy-to-stripping butterfly-shaped photoelectric composite communication optical cable comprises an optical cable part 1 and a cable part 2 fixedly connected to a side of the optical cable part 1, the optical cable part 1 comprises an optical transmission conductor 11, an optical cable sheath 12 arranged on outer surface of the optical transmission conductor 11 and extending parallel to the optical transmission conductor 11, and reinforcing components 13 arranged inside the optical cable sheath 12 and respectively arranged on both sides of the optical transmission conductor 11, the reinforcing component 13 extends parallel to the same direction as the optical transmission conductor 11, the cable part 2 comprises a cable sheath 21 fixedly connected to outer side of the optical cable sheath 12, an electrical transmission conductor 22 arranged inside the cable sheath 21, the electric transmission conductor 22 extends parallel to the same direction as the optical transmission conductor 11, and photoelectric separation ports 3 are provided between the cable sheath 21 and the optical cable sheath 12.

The optical cable part 1 is arranged separately from the cable part 2, and the magnetic field generated when the cable part 2 transmits power has a certain distance from the optical cable part 1, which does not affect the signal transmission of the optical cable part 1, and ensures the quality of the signal transmission of the optical fiber 112. When it is necessary to strip the optical fiber 112 and the electrical transmission conductor 22 from the photoelectric separation port 3 for indoor connection, it is convenient for the user to grasp the application and apply force better. A photoelectric separation port 3 is provided between the cable sheath 21 and the optical cable sheath 12, which is convenient for the cable part 2 and the optical cable part 1 to be stripped for installation. The application has the advantages of simple structure, small cable diameter and light cable weight, thereby reducing the cost of the optical cable.

On the basis of the above embodiments, as a further preference, the optical cable sheath 12 comprises a first sheath 121 and a second sheath 122 with a circular cross section, a left side of the cross section of the first sheath 121 intersects the right side of the cross section of the second sheath 122 to form a lying “8” shape, at intersections of outer contours of the first sheath 121 and the second sheath 122, inwardly directed optical cable separation ports 123 are respectively provided, and two optical cable separation ports 123 are provided, the optical transmission conductor 11 is located in middle of the two optical cable separation ports 123. The first sheath 121, the second sheath 122, the optical cable separation ports 123, the cable sheath 21, the photoelectric separation ports 3 are integrally formed.

The first sheath 121, the second sheath 122, the optical cable separation ports 123, the cable sheath 21, the photoelectric separation ports 3 are integrally formed, and the interior is more stable than the traditional lead-M optical cable, and is more suitable for long-distance overhead. The left side of the cross section of the first sheath 121 intersects with the right side of the second sheath 122 to form a lying “8” shape, which is convenient for the user to grasp the application and apply force better. The optical transmission conductor 11 is arranged at middle of the two optical cable separation ports 123, so that the force on the optical cable sheath 12 is more uniform and easier to bear when tearing the application, which makes the optical cable sheath 12 easier to be stripped.

On the basis of the above embodiments, as a further preference, the first sheath 121 and the second sheath 122 have the same diameter, the cross section of the cable sheath 21 is circular, and the diameter of the cable sheath 21 is smaller than the diameters of the first sheath 121 and the second sheath 122.

The diameters of the first sheath 121 and the second sheath 122 are the same, which is convenient for taking the application. The diameter of the cable sheath 21 is smaller than the diameters of the first sheath 121 and the second sheath 122, so that the cable diameter of the present application is small and the cable weight is light, thereby reducing the cost of the optical cable.

On the basis of the above embodiments, as a further preference, the reinforcing component 13 comprises a first reinforcing member 131 arranged in the first sheath 121, a second reinforcing member 132 arranged in the second sheath 122, the optical transmission conductor 11 comprises a tight sleeve 111 arranged between two optical cable separation ports 123, an optical fiber 112 arranged in the tight sleeve 111, the cross section of the first reinforcing member 131 and the second reinforcing member 132 is circular and have the same diameter, a diameter of the tight sleeve 111 is smaller than the diameters of the first reinforcing member 131 and the second reinforcing member 132, a distance from center of a circle of the first reinforcing member 131 to center of a circle of the second sheath 122 is equal to a distance from center of a circle of the second reinforcing member 132 to center of a circle of the second sheath 122.

By the first reinforcing member 131 and the second reinforcing member 132, the application has stronger bearing capacity and better tensile strength, so that the application is more suitable for long-distance overhead, and when the application is torn by the user. It is easier to take, and the force on the first sheath 121 and the second sheath 122 is more uniform and easier to bear force. In the present application, the distance from the center of the circle of the first strengthening member 131 to the center of the circle of the second sheath 122 is equal to the distance from the center of the circle of the second strengthening member 132 to the center of the circle of the second sheath 122, so that the force on the optical cable sheath 12 is more uniform, making the optical cable sheath 12 easier to be stripped, and at the same time strengthening the protection of the optical cable sheath 12 to the optical transmission conductor 11, which can ensure that the application is suitable for indoor and outdoor use.

On the basis of the above embodiments, as a further preference, centers of the electrical transmission conductor 22, the first reinforcing member 131, the tight sleeve 111, the optical fiber 112 and the second reinforcing member 132 are located on the same straight line. The electrical transmission conductor 22 is separated from the optical fiber 112 by a certain distance, and the magnetic field generated when the electrical transmission conductor 22 transmits power has a certain distance from the optical fiber 112, which does not affect the signal transmission of the optical cable part 1, and is also convenient for users to grasp the application.

The above descriptions are only preferred embodiments of the present application. It should be pointed out that those skilled in the art can make some improvements and modifications without departing from the principle of the present application, and these improvements and modifications should also be regarded as the protection scope of the present application.

What is claimed is:

1. A miniature and easy-to-stripping butterfly-shaped photoelectric composite communication optical cable, comprising an optical cable part (1) and a cable part (2) fixedly connected to a side of the optical cable part (1), the optical cable part (1) comprises an optical transmission conductor (11), an optical cable sheath (12) arranged on outer surface of the optical transmission conductor (11) and extending parallel to the optical transmission conductor (11), and reinforcing components (13) arranged inside the optical cable sheath (12) and respectively arranged on both sides of the optical transmission conductor (11), the reinforcing component (13) extends parallel to the same direction as the optical transmission conductor (11), the cable part (2) comprises a cable sheath (21) fixedly connected to outer side of the optical cable sheath (12), an electrical transmission conductor (22) arranged inside the cable sheath (21), the electric transmission conductor (22) extends parallel to the same direction as the optical transmission conductor (11), and photoelectric separation ports (3) are provided between the cable sheath (21) and the optical cable sheath (12).

2. The miniature and easy-to-stripping butterfly-shaped photoelectric composite communication optical cable according to claim 1, wherein the optical cable sheath (12) comprises a first sheath (121) and a second sheath (122) with a circular cross section, a left side of the cross section of the first sheath (121) intersects the right side of the cross section of the second sheath (122) to form a lying “8” shape, at intersections of outer contours of the first sheath (121) and the second sheath (122), inwardly directed optical cable separation ports (123) are respectively provided, and two optical cable separation ports (123) are provided, the optical transmission conductor (11) is located in middle of the two optical cable separation ports (123), the first sheath (121), the second sheath (122), the optical cable separation ports (123), the cable sheath (21), the photoelectric separation ports (3) are integrally formed.

3. The miniature and easy-to-stripping butterfly-shaped photoelectric composite communication optical cable according to claim 2, wherein the first sheath (121) and the second sheath (122) have the same diameter, the cross section of the cable sheath (21) is circular, and the diameter of the cable sheath (21) is smaller than the diameters of the first sheath (121) and the second sheath (122).

4. The miniature and easy-to-stripping butterfly-shaped photoelectric composite communication optical cable according to claim 2, wherein the reinforcing component (13) comprises a first reinforcing member (131) arranged in the first sheath (121), a second reinforcing member (132) arranged in the second sheath (122), the optical transmission conductor (11) comprises a tight sleeve (111) arranged between two optical cable separation ports (123), an optical fiber (112) arranged in the tight sleeve (1.11), the cross section of the first reinforcing member (131) and the second reinforcing member (132) is circular and have the same diameter, a diameter of the tight sleeve (111) is smaller than the diameters of the first reinforcing member (131) and the second reinforcing member (132), a distance from center of a circle of the first reinforcing member (131) to center of a circle of the second sheath (122) is equal to a distance from center of a circle of the second reinforcing member (132) to center of a circle of the second sheath (122).

5. The miniature and easy-to-stripping butterfly-shaped photoelectric composite communication optical cable according to claim 4, wherein centers of the electrical transmission conductor (22), the first reinforcing member (131), the tight sleeve (1.11), the optical fiber (112) and the second reinforcing member (132) are located on the same straight line.
